(19) United States
(12) Patent Application Publication
(10) Pub. No.: US 2009/0247143 A1
(43) Pub. Date: Oct. 1, 2009

(54) MOBILE PHONE, AND METHOD OF LIMITING OPERATIONS OF MOBILE PHONE

(75) Inventors: Yoshifumi HAYASHI, Tokyo (JP); Miho UTSUNO, Tokyo (JP); Akinobu IGARASHI, Tokyo (JP)

Correspondence Address: FRISHAUF, HOLTZ, GOODMAN & CHICK, PC, 220 Fifth Avenue, 16TH Floor, NEW YORK, NY, 10001-7708, US

(73) Assignee: KABUSHIKI KAISHA TOSHIBA, Tokyo (JP)

(21) Appl. No.: 12/329,808

(22) Filed: Dec. 8, 2008

(30) Foreign Application Priority Data
Mar. 28, 2008 (JP) P2008-087293

(51) Int. Cl. H04M 3/00

(52) U.S. Cl. 455/418

(57) ABSTRACT

The present invention provides a mobile phone which is capable of giving a high priority to communication with a party that corresponds to a particular phone number, and which is capable of allowing the settings of whether or not the priority function is to be enabled to be easily made.

The mobile phone includes: a first judging unit (S105) which judges whether or not the caller of the incoming call matches a predetermined phone number if the incoming call signal is received; and a limiting unit (S109) configured such that, in a case in which the first judging unit judges the caller of the incoming call matches the predetermined phone number, the limiting unit limits the operations other than an incoming call response operation.

### BACKGROUND OF THE INVENTION

1. Field of the Invention

The present invention relates to a mobile phone and a method for limiting operations of a mobile phone which are capable of giving high priority to a particular phone number for communication based upon the setting information with respect to the communication priority function.

2. Description of the Related Art

In recent years, mobile phones have come into widespread use. For the purpose of security, many parents have come to give mobile phones to their children to take to school. Such mobile phones have a function of registering a phone number in an incoming call rejection list, and a function of registering a phone number in incoming call priority list.

For example, a mobile phone is described in Japanese Unexamined Patent Application Publication No. 2005-101819, having a function of switching the standby method among various settings such as a setting for giving high priority to a particular phone number, etc., according to the place where the user receives an incoming call or various situations assumed by the user himself/herself, in addition to a simple function of rejecting a particular phone number. This mobile phone has: a function of allowing the user to register a desired phone number in an incoming call rejection list; a function of allowing the user to register a desired phone number in an incoming call priority list which is a list other than the incoming call rejection list; a function of judging whether or not the phone number of a received incoming call has been registered in the incoming call rejection list, and whether or not the phone number has been registered in the incoming call priority list; a function whereby, in a case in which the phone number of the received incoming call has been registered in the incoming call rejection list, and in a case in which the phone number has not been registered in the phone number priority list, the incoming call of this phone number is rejected; a function whereby, in a case in which the phone number of the received incoming call has not been registered in the incoming call rejection list, and in a case in which the phone number has been registered in the phone number priority list, an operation is performed so as to notify the user that a call is coming; and a function whereby, in a case in which the phone number of the received incoming call has been registered in the incoming call rejection list, and in a case in which the phone number has been registered in the phone number priority list, an operation is performed so as to notify the user that a call is coming.

Such a mobile phone, which has a function of allowing the user to register a particular phone number in an incoming call rejection list or an incoming call priority list, has a problem in that, once a particular phone number has been registered in the rejection list or the priority list, it is difficult for the user to determine the timing at which deregistration should be performed. Currently, a greater number of parents have come to give mobile phones to their children for the purpose of security. In order to ensure the security, such a mobile phone must have a function of ensuring the communication with their children in emergency situations.

The present invention has been made in view of the aforementioned problems. Accordingly, it is an object of the present invention to provide a mobile phone and a method for limiting operations of a mobile phone having a function of allowing the communication priority function to be easily enabled and disabled, in addition to the communication priority function of giving high priority to a particular phone number for communication.

### SUMMARY OF THE INVENTION

In order to solve the aforementioned problems, a mobile phone according to the present invention comprises: a first judging unit which judges whether or not the caller of an incoming call matches a predetermined phone number if the incoming call signal is received; and a limiting unit configured such that, in a case in which the first judging unit judges that the caller of the incoming call matches the predetermined phone number, the limiting unit limits operations other than an incoming call response operation.

And, a method for limiting operations of a mobile phone according to the present invention comprises: a first judging step of judging whether or not the caller of an incoming call matches a predetermined phone number if the incoming call signal is received; and a limiting step of limiting operations other than an incoming call response operation in a case in which the first judging unit judges that the caller of the incoming call matches the predetermined phone number.

The mobile phone and the method for limiting operations of the mobile phone according to the present invention give high priority to communication with a party that corresponds to a particular phone number. By giving the mobile phone according to the present invention to a child, and by setting the parent's phone number to the high-priority phone number, such an arrangement allows the parent to communication with his/her child without concern about disconnection of the communication while giving consideration to the child's current situation in school, thereby giving a feeling of security to the parent.

### BRIEF DESCRIPTION OF THE DRAWINGS

FIG. 1A is a front view which shows a mobile phone in an opened state according to the present invention;

FIG. 1B is a side view which show the mobile phone in the opened state according to the present invention;

FIG. 2A is a front view which shows the mobile phone in a closed state according to the present invention;

FIG. 2B is a side view which show the mobile phone in the closed state according to the present invention;

FIG. 3 is a function block diagram which shows the mobile phone according to the present invention;

FIG. 4 is a data configuration diagram which indicates setting information;

FIG. 5A through FIG. 5G are views of screens which allow the setting information to be input;

FIG. 6 is a flowchart which shows the procedure used by the mobile phone according to the present invention so as to perform communication priority processing (processing for forbidding the operations other than the incoming call response operation);

FIG. 7 is a flowchart which shows the procedure used by the mobile phone according to the present invention so as to perform communication priority processing (processing for transmitting a position notice mail);

FIG. 8 is a flowchart which shows the procedure used by the mobile phone according to the present invention so as to perform communication priority processing (processing for giving high priority to communication with a party that corresponds to a high-priority phone number)

FIG. 9 is a flowchart which shows the procedure used by the mobile phone according to the present invention so as to perform communication priority processing (processing for forbidding disconnection);

FIG. 10 is a flowchart which shows the procedure used by the mobile phone according to the present invention so as to perform communication priority processing (processing for giving high priority to an incoming call from the high-priority phone number); and

FIG. 11 is a flowchart which shows the procedure used by the mobile phone according to the present invention so as to perform communication priority processing (processing for rejecting an incoming call).

### DESCRIPTION OF THE PREFERRED EMBODIMENTS

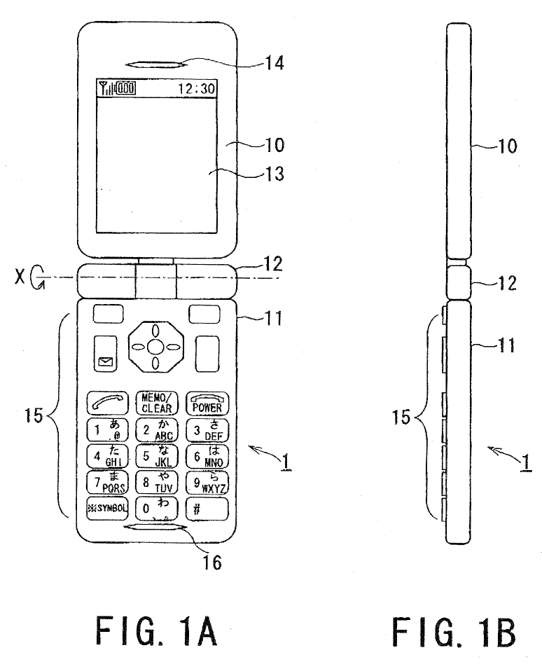

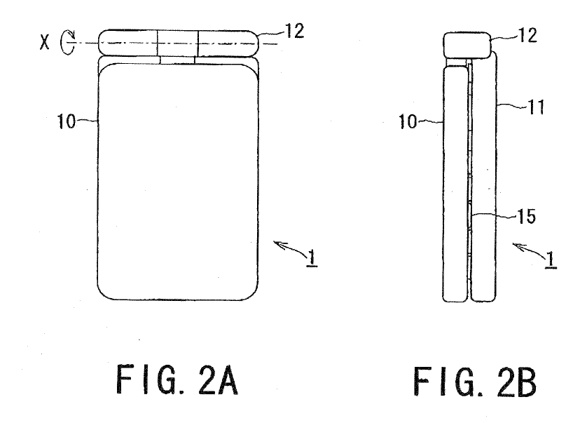

Description will be made regarding a mobile phone according to an embodiment of the present invention with reference to the accompanying drawings. Description will be made regarding a clamshell mobile phone 1 configured of multiple casings hinged to one another so as to allow the user to open and close the mobile phone 1, as an example of the mobile phone according to the present invention. FIG. 1A is a front view which shows the mobile phone 1 in the opened state. FIG. 1B is a side view which shows the mobile phone 1 in the opened state. FIG. 2A is a front view which shows the mobile phone 1 in the closed state. FIG. 2B is a side view which shows the mobile phone 1 in the closed state.

As shown in FIG. 1 and FIG. 2, the mobile phone 1 is configured of an upper casing 10 formed in shape of a rectangular plate and an lower casing 11 having approximately the same shape such that they lie on top of each other. These upper casing 10 and the lower casing 11 are hinged with a hinge portion 12 positioned therebetween. The mobile phone 1 is configured so as to allow the user to turn the upper casing 10 relatively to the lower casing 11 with the hinge portion 12 as a turning axis by a predetermined angle in the X direction shown in FIG. 1A. Such an arrangement allows the user to switch the state of the mobile phone 1 between the opened state and the closed state by turning the upper casing 10 relatively to the lower casing 11.

The inside face of the upper casing 10 (the face that faces the lower casing 11) includes a display 13 for displaying text and images, an address book, mails which have been transmitted or received, and a speaker 14 for outputting an acoustic sound. When the mobile phone 1 is in the closed state, the display 13 and the speaker 14 are covered with the lower casing 11, and are not exposed to view from the outside. On the other hand, when the mobile phone 1 is switched to the opened state by turning the upper casing 10 relative to the lower casing 11, the display 13 and the speaker 14 are exposed to view from the outside.

The inside face of the lower casing 11 (the face that faces the upper casing 10) includes operation keys 15, e.g., a cross key which allows the user to move a cursor in the vertical direction and the horizontal direction, numeric keys which allows the user to input numerals, a call key which allows the user to perform call processing, an on-hook key which allows the user to end communication, a forwarding key which allows the user to forward an incoming call, a holding key which allows the user to put an incoming call on hold, a rejection key which allows the user to reject an incoming call, etc. Furthermore, the lower casing 11 includes a microphone 16 for acquiring acoustic sound. When the mobile phone 1 is in the closed state, the operation keys 15 and the microphone 16 are covered with the lower casing 11, and are not exposed to view from the outside. On the other hand, when the mobile phone 1 is switched to the opened state by turning the upper casing 10 relative to the lower casing 11, these components are exposed to view from the outside.

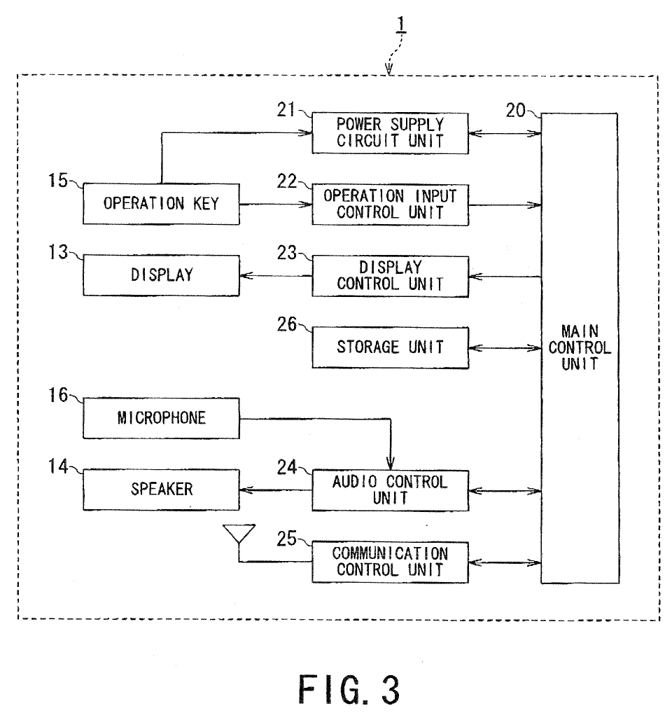

Next, description will be made regarding the functions of the mobile phone 1 with reference to the function block diagram shown in FIG. 3. As shown in FIG. 3, the mobile phone 1 comprises a main control unit 20, a power supply circuit unit 21, an operation input control unit 22, a display control unit 23, an audio control unit 24, a communication control unit 25, and a storage unit 23, connected to one another via a bus.

The main control unit 20 includes a CPU (Central Processing Unit). The main control unit 20 performs an overall control operation for the mobile phone 1, communication priority processing described later, various kinds of other computation processing and control processing, etc. The power supply circuit unit 21 switches the power supply between the ON state and the OFF state based upon the input operation performed by the user via the operation keys 15. When the power supply is in the ON state, electric power is supplied to each component from a power supply source (battery or the like), thereby switching the mobile phone 1 to the operable state.

The operation input control unit 12 includes an input interface for the operation keys 15. The operation input control unit 12 transmits an signal input via the operation keys 15 to the main control unit 20. The display control unit 23 includes a display interface for the display 13. The display control unit 23 displays document data, image data, etc., on the display 13 under the control of the main control unit 20.

Under the control of the main control unit 20, the audio control unit 24 generates an analog audio signal from the acoustic sound acquired by the microphone 16, and converts the analog audio signal into a digital audio signal. Furthermore, when the audio control unit 24 acquires a digital audio signal, the audio control unit 24 converts the digital audio signal into an analog audio signal, and outputs the analog audio signal via the speaker 14 in the form of sound, under the control of the main control unit 20.

Under the control of the main control unit 20, the communication control unit 25 reconstructs the data by performing spectrum despreading processing on a signal received from the base station (not shown) via an antenna 25. The data is transmitted to the audio control unit 24 and is output via the speaker 14, or is transmitted to the display control unit 23 and is displayed on the main display 13, or is stored in a storage unit 26, according to an instruction from the main control unit 20. Furthermore, under the control of the main control unit 20, when the communication control unit 25 acquires the audio data captured by the microphone 16, the data input via the operation keys 15, or the data stored in the storage unit 26, the communication control unit 25 performs the spectrum despreading processing on the data, and transmits the data thus subjected to the spectrum despreading processing to the base station via the antenna 25a.

The storage unit 26 has a configuration including ROM (Read Only Memory), a hard disk, or nonvolatile memory, which stores a processing program for processing to be performed by the main control unit 20, data which is necessary for the processing, etc., and RAM (Random Access Memory) which temporarily stores the database and data to be used in the processing performed by the main control unit 20, etc. Let us say that the processing program used by the main control unit 20 for performing the communication priority processing described later is stored in the ROM, for example.

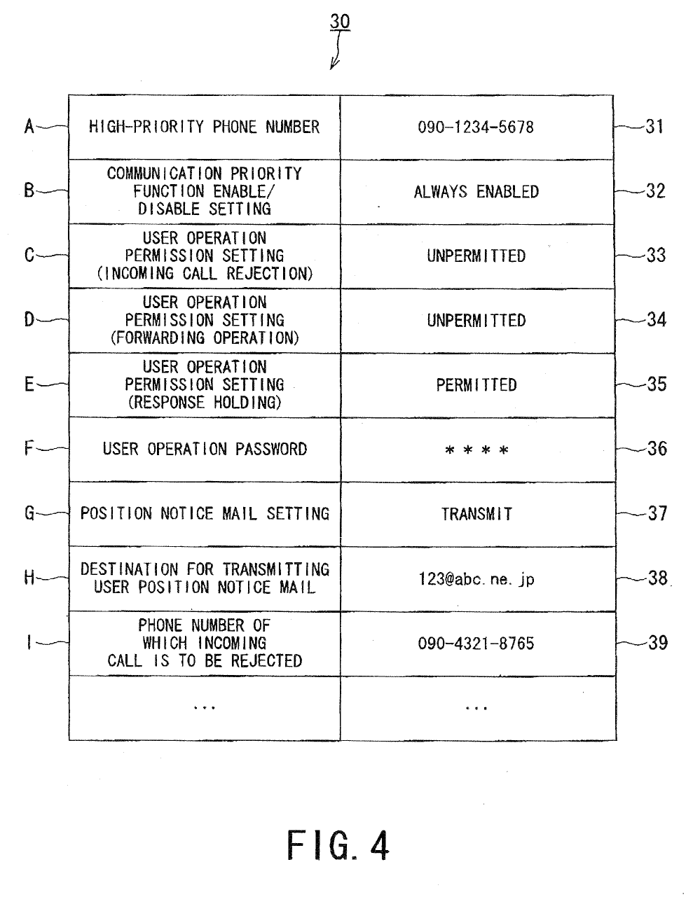

Furthermore, the storage unit 26 stores setting information 30 for performing the communication priority processing. As shown in FIG. 4, the setting information 30 includes: high-priority phone number information 31 which indicates a high-priority phone number; communication priority function enable/disable setting information 32 which indicates whether or not the communication priority function is to be enabled; incoming call rejection permission setting information 33 which indicates whether or not the user is permitted to reject a call; forwarding permission setting information 34 which indicates whether or not the user's forwarding operation is to be permitted; incoming call response holding permission setting information 35 which indicates whether or not the user is permitted to put a call on hold; user operation password information 36 which indicates a password necessary for the user to perform an operation; position notice mail setting information 37 which indicates whether or not a position notice mail is to be transmitted; destination information 38 which indicates a destination mail address to which the user position notice mail is to be transmitted; and incoming call rejection information 39 which indicates a phone number which is to be subjected to incoming call rejection.

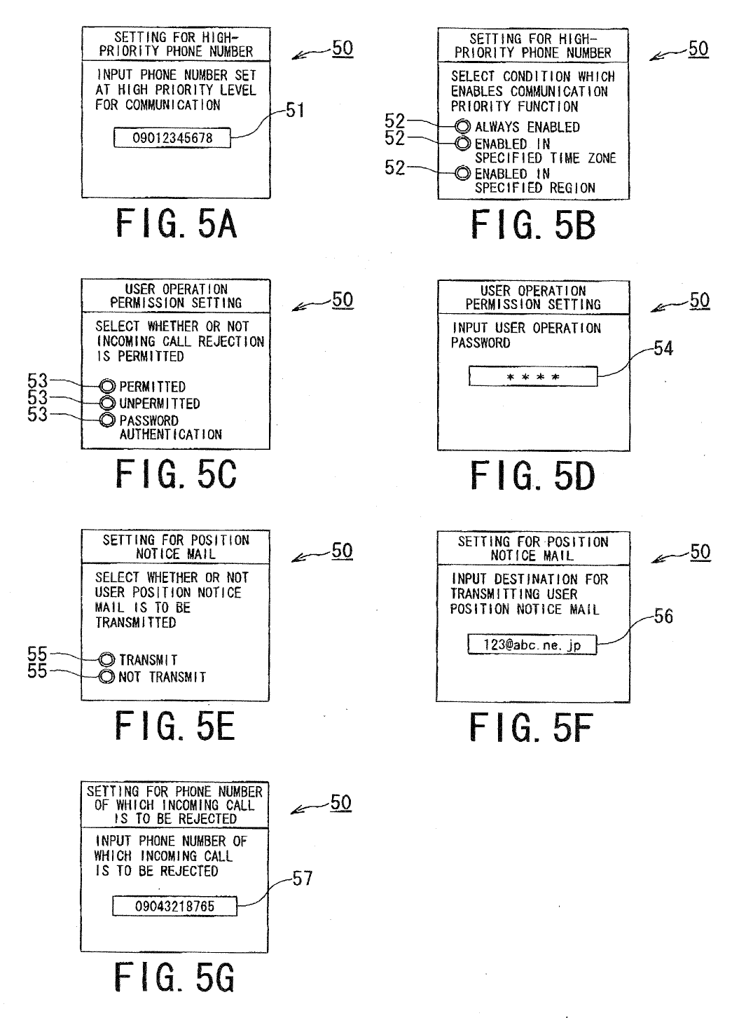

As shown in FIG. 5A, the setting of the high-priority phone number information 31 is made by inputting a phone number in an input field 51 displayed on a display screen 50 on the display 13 via the operation keys 15. As shown in FIG. 5B, the settings of communication priority function enable/disable setting information 32 are made by selecting, via the operation keys 15, one from among multiple options displayed on the display screen 50. In this case, the options include an “always enabled” option, an “enabled at specified time” option, a “enabled at a specified region” option, etc. In a case in which the “enabled at specified time” option or the “enabled at a specified region” option has been selected, the time zone or the region in which the function is to be enabled is input, in addition.

As shown in FIG. 5C, each of the incoming call rejection permission setting information 33, the forwarding permission setting information 34, and the incoming call holding permission setting information 35 is set by selecting one from among multiple options 53 displayed on the display screen 50 via the operation keys 15. In this case, the options include a “permitted” option, an “unpermitted” option, a “password authentication” option, etc. The “password authentication” option is an option in which, only when the user inputs a password which permits the user to perform an operation, the function is permitted.

As shown in FIG. 5D, the user, operation password information 36 is set by inputting a password in an input field 54 displayed on the display screen 50 via the operation keys 15. The password is a password used by the user himself/herself who is the child or the like. As shown in FIG. 5E, the position notice mail setting information 37 is set by selecting one from among multiple options 55 displayed on the display screen 50 via the operation keys 15. In this case, the options include a “transmitting” option, an “untransmitting” option, etc.

As shown in FIG. 5F, the destination information 38 is set by inputting a mail address in an input field 56 displayed on the display screen 50 via the operation keys 15. As shown in FIG. 5G, the incoming call rejection information 39 is set by inputting a phone number in an input field 57 displayed on the display screen 50 via the operation keys 15.

It should be noted that, before the setting information 30 is set, or before the setting information 30 is changed, the mobile phone 1 prompts input of a password or the like, thereby permitting only a predetermined authorized person such as the parent of the user of the mobile phone 1 or the like to set and change the setting information 30.

For example, in the setting information 30 shown in FIG. 4, a phone number “090-1234-5678” is set for the high-priority phone number information 31, the “always enabled” option is set for the communication priority function enable/disable setting information 32, the “unpermitted” option is set for the incoming call rejection permission setting information 33, the “unpermitted” option is set for the forwarding permission setting information 34, the “permission” option is set for the incoming call response holding permission setting information 35, the password “****” is set for the user operation password information 36, the “transmitting” option is set for the position notice mail setting information 37, the address “123@abc.ne.jp” is set for the destination information 38, and the phone number “090-4321-8765” is set for the incoming call rejection information 39.

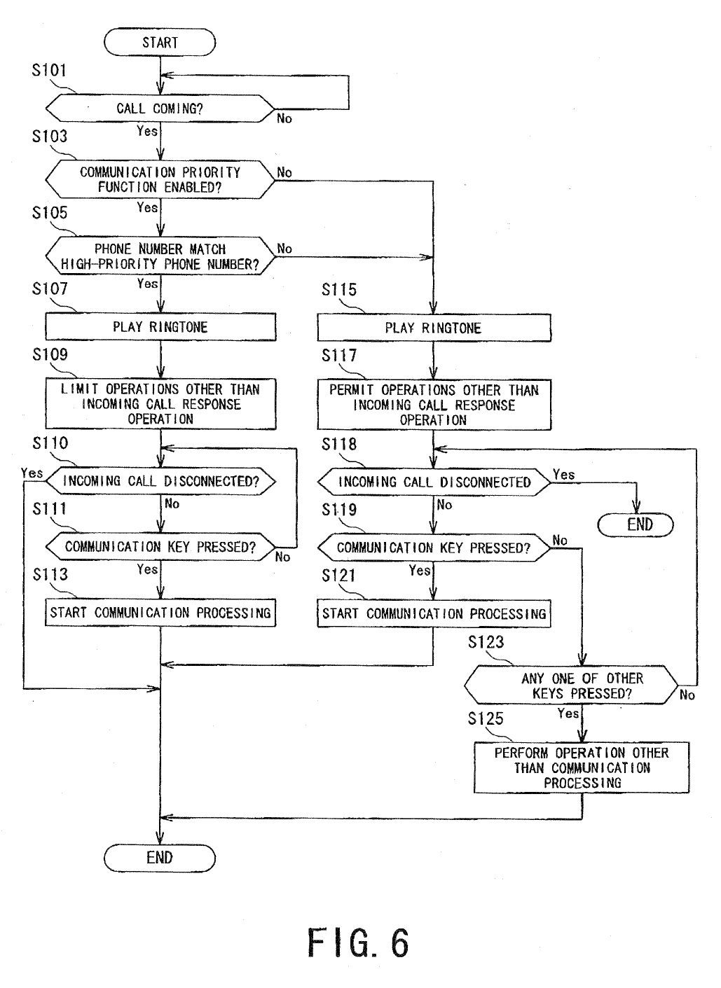

The mobile phone 1 performs various kinds of communication priority processing based upon the setting information 30. First, description will be made with reference to the flowchart shown in FIG. 6 regarding the procedure of the communication priority processing for limiting the user's operations other than the incoming call response operation, which is performed based upon the setting information 30 when the mobile phone 1 receives an incoming call from a caller that corresponds to the high-priority phone number. In the following description, “Step S101” will be abbreviated to “S101”, for example, omitting “Step”.

First, the main control unit 20 judges whether or not an incoming call signal is received (S101). In a case in which no incoming call signal is received (in a case of “NO” in S101), the main control unit 20 maintains the standby state. In a case in which an incoming call signal is received (in a case of “YES” in S101), the main control unit 20 judges whether or not the communication priority function is in the enabled state (S103). In this stage, the main control unit 20 acquires the communication priority function enable/disable setting information 32 from the storage unit 26, and makes determination whether or not the communication priority function is in the enabled state, based upon the information thus acquired. For example, in a case of using the setting information 30 shown in FIG. 4, the “always enabled” option is set for the communication priority function enable/disable setting information 32, and accordingly, determination is made that the communication priority function is in the enabled state.

In a case in which the communication priority function is in the enabled state (in a case of YES in S103), the main control unit 20 determines whether or not the phone number that corresponds to the incoming call received in S101 matches the high-priority phone number (S107). In this stage, the main control unit 20 acquires the high-priority phone number information 31 from the storage unit 26, and judges whether or not the phone number of the incoming call matches the high-priority phone number. For example, referring to the setting information 30 shown in FIG. 4, the phone number “090-1234-5678” is set for the high-priority phone number information 31. Accordingly, in a case in which there is an incoming call of this phone number in Step S101, determination is made that the phone number that corresponds to the incoming call matches the high-priority phone number.

In a case in which the phone number that corresponds to the incoming call matches the high-priority phone number (in a case of “YES” in S107), the main control unit 20 plays a ringtone, thereby notifying the user that a call is coming (S107). Furthermore, the main control unit 20 limits the user's operations other than the incoming call response operations (S109). In this stage, the main control unit 20 acquires the incoming call rejection permission setting information 33, the forwarding permission setting information 34, and the incoming call response holding permission setting information 35, from the storage unit 26, and limits the user's operations other than the incoming call response operation based upon these information items. For example, referring to the setting information 30 shown in FIG. 4, the “unpermitted” option is set for the incoming call rejection permission setting information 33, the “unpermitted” option is set for the forwarding permission setting information 34, and the “permitted” option is set for the incoming call response holding permission setting information 35. In this case, the user is not permitted to perform the incoming call rejecting operation and the forwarding operation, and is permitted to perform only the operation for holding the response to the incoming call.

The main control unit 20 determines whether or not the incoming call has been disconnected by the caller (S110). In a case in which the incoming call has been disconnected (in a case of YES in S110), the main control unit 20 ends the communication priority processing.

In a case in which the incoming call has not been disconnected (in a case of NO in S110), the main control unit 20 determines whether or not the communication key has been pressed (S111). In a case in which the communication key has not been pressed (in a case of NO in S111), the flow returns to Step s110 in which the main-control unit 20 determines whether or not the incoming call has been disconnected. In a case in which the communication key has been pressed (in a case of YES in S111), the main control unit 20 starts communication processing for the caller that corresponds to the incoming call received in Step S101, i.e., for the high-priority phone number (S113).

In a case in which the communication priority function is not in the enabled state (in a case of NO in S103), or in a case in which the phone number that corresponds to the incoming call received in Step S101 does not match the high-priority phone number (in a case of NO in S105), the main control unit 20 plays a ringtone, thereby notifying the user that a call is coming (S115). Furthermore, the main control unit 20 permits the user to perform the operations other than the incoming call response operation (S117).

The main control unit 20 determines whether or not the incoming call has been disconnected by the caller (S118). In a case in which the incoming call has been disconnected (in a case of YES in S118), the main control unit 20 ends the communication priority processing.

In a case in which the incoming call has not been disconnected (in a case of YES in S118), the main control unit 20 determines whether or not the communication key has been pressed (S119). In a case in which the communication key has been pressed (in a case of YES in S119), the main control unit 20 starts communication with the caller that corresponds to the incoming call (phone number other than the high-priority phone number) received in Step S101 (S121). In a case in which the communication key has not been pressed (in a case of NO in S119), the main control unit 20 determines whether or not any one of other keys has been pressed (S123). In a case in which any one of other keys has not been pressed (in a case of NO in S123), the flow returns to Step S118 in which the main control unit 20 determines whether or not the incoming call has been disconnected.

In a case in which any one of the other keys has been pressed (in a case of YES in S123), the main control key 20 performs processing associated with the key thus pressed, and which differs from the communication processing (S125). The reason is that the caller does not match the high-priority phone number, and accordingly, the user is also permitted to perform operations that differ from the incoming call response operation.

As described above, when the communication priority function is in the enabled state, in a case in which there is an incoming call that corresponds to the high-priority phone number, the mobile phone 1 limits the user's operations other than the incoming call response operation (e.g., incoming call rejection, forwarding operation, incoming call response holding operation, operation for responding with an answering service) based upon the setting information 30.

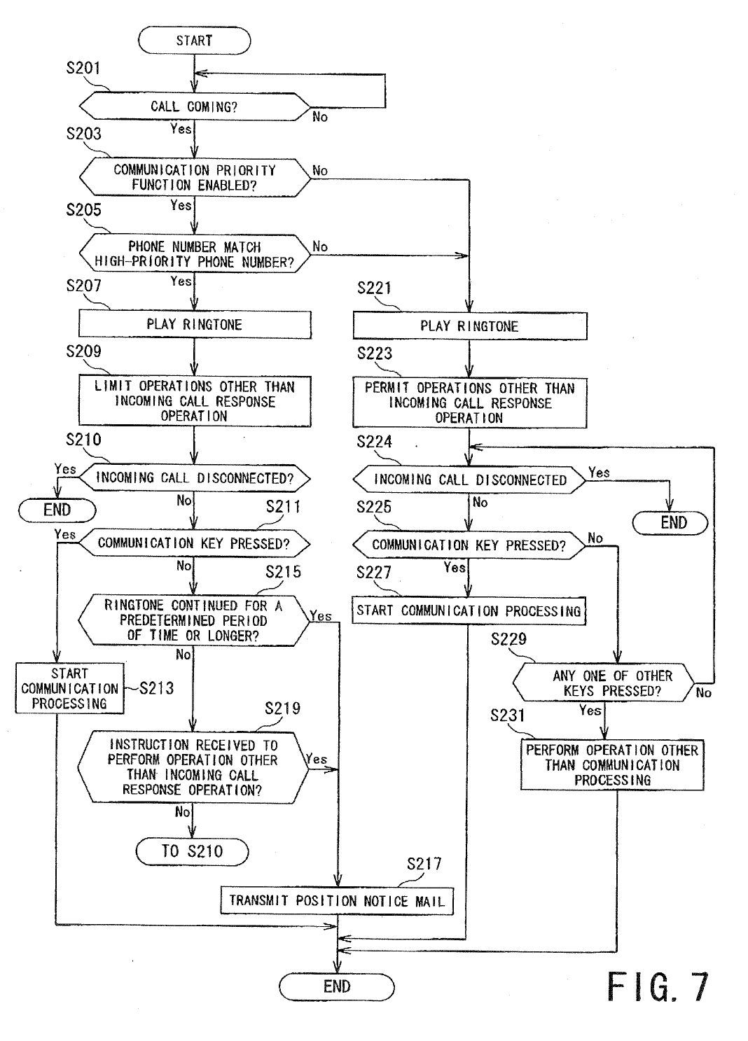

Next, description will be made with reference to the flowchart shown in FIG. 7 regarding the procedure of the communication priority processing in which, in a case in which there is an incoming call from the caller that corresponds to the high-priority phone number, and in a case in which the user has not responded to the incoming call, or the user has performed an operation other than the incoming call respond operation, the mobile phone 1 transmits a mail to the destination for the user position notice mail. Let us say that the “transmitting” option is set for the position notice mail setting information 37 in the setting information 30.

First, the main control unit 20 determines whether or not an incoming call signal is received (S201). In a case in which no incoming call signal is received (in a case of NO in S201), the main control unit 20 maintains the standby state. In a case in which an incoming call signal is received (in a case of YES in S201), the main control unit 20 judges whether or not the communication priority function is in the enabled state (S203). In this stage, the main control unit 20 acquires the communication priority function enable/disable setting information 32 from the storage unit 26, and judges, based upon the information thus acquired, whether or not this function is in the enabled state. For example, referring to the setting information 30 shown in FIG. 30, the “always enabled” option is set for the communication priority function enable/disable setting information 32. Accordingly, determination is made that the communication priority function is in the enabled state.

In a case in which the communication priority function is in the enabled state (in a case of YES in S203), the main control unit 20 determines whether or not the phone number that corresponds to the incoming call received in Step S101 matches the high-priority phone number (S205). In this stage, the main control unit 20 acquires the high-priority phone number information 31 from the storage unit 26, and judges, based upon the information thus acquired, whether or not the phone number that corresponds to the incoming call matches the high-priority phone number. For example, referring to the setting information 30 shown in FIG. 4, the phone number “090-1234-5678” is set for the high-priority phone number information 31. Accordingly, in a case in which the mobile phone 1 has received an incoming call that corresponds to this phone number in Step S201, determination is made that the phone number that corresponds to the incoming call matches the high-priority phone number.

In a case in which the phone number that corresponds to the incoming call matches the high-priority phone number (in a case of YES in S205), the main control unit 20 plays a ringtone so as to notify the user that a call is coming (S207). Furthermore, the main control unit 20 limits the user's operations other than the incoming call response operation (S209). In this stage, the main control unit 20 acquires the incoming call rejection permission setting information 33, the forwarding permission setting information 34, and the incoming call response holding permission setting information 35, from the storage unit 26, and limits the operations other than the incoming call response operation based upon these information items. For example, referring to the setting information 30 shown in FIG. 4, the “unpermitted” option is set for the incoming call rejection permission setting information 33, the “unpermitted” option is set for the forwarding permission setting information 34, and the “permitted” option is set for the incoming call response holding permission setting information 35. Accordingly, the user is not permitted to perform the incoming call rejecting operation and the forwarding operation, and is permitted to perform only the incoming call response holding operation.

The main control unit 20 judges whether or not the incoming call has been disconnected by the caller (S210). In a case in which the incoming call has been disconnected (in a case of YES in S210), the main control unit 20 ends the communication priority processing.

In a case in which the incoming call has not been disconnected (in a case of NO in S210), the main control unit 20 judges whether or not the communication key has been pressed (S211). In a case in which the communication key has been pressed (in a case of YES in S211), the main control unit 20 starts communication with the caller that corresponds to the incoming call (phone number other than the high-priority phone number) received in Step S201 (S213). In a case in which the communication key has not been pressed (in a case of NO in S211), the main control unit 20 judges whether or not the ringtone has been played for a predetermined period (e.g., 5 seconds) or longer.

In a case in which the ringtone has been played for a predetermined period or longer (in a case of YES in S215), i.e., in a case in which the user has not responded to the call for the predetermined period or longer, the main control unit 20 transmits a position notice mail including the position information of the mobile phone 1 (S217). In this stage, the main control unit 20 acquires the destination information 38 from the storage unit 26, and transmits the position notice mail to the mail address indicated by the destination information 38. For example, referring to the setting information 30 shown in FIG. 4, the mail address “123@abc.ne.jp” is set for the destination information 38. Accordingly, the position transmission mail is transmitted to this mail address.

In a case in which the ringtone has not been played for a predetermined period or longer (in a case of NO in S215). The main control unit 20 judges whether or not there is an instruction to perform an operation other than the incoming call response operation (S219). Referring to the setting information 30 shown in FIG. 4, the “unpermitted” option is set for the “incoming call rejection permission setting information 33, the “unpermitted” option is set for the forwarding permission setting information 34, and the “permitted” option is set for the incoming call response holding permission setting information 35. In this state, in Step S209, the user is permitted to perform only the incoming call response holding operation. Accordingly, in this case, determination is made whether or not there is an instruction to perform the incoming call response holding operation.

In a case in which there is not an instruction to perform an operation other than the incoming call response operation (in a case of NO in S219), the flow returns to Step S210 in which the main control unit 20 judges whether or not the incoming call has been disconnected. In a case in which there is an instruction to perform an operation other than the incoming call response operation (in a case of YES in S219), the main control unit 20 transmits a position notice mail, which includes the position information of the mobile phone 1, to the destination set in the destination information 38 (S217).

In a case in which the communication priority function is not in the enabled state (in a case of NO in S203), or in a case in which the caller that corresponds to the incoming call received in Step S201 does not match the high-priority phone number (in a case of NO in S205), the main control unit 20 plays the ringtone so as to notify the user that a call is coming (S221). Furthermore, the main control unit 20 permits the user to perform operations that differ from the incoming call response operation (S223).

The main control unit 20 judges whether or not the incoming call has been disconnected by the caller (S224). In a case in which the incoming call has been disconnected (in a case of YES in S224), the main control unit 20 ends the communication priority processing.

In a case in which the incoming call has not been disconnected (in a case of NO in S224), the main control unit 20 judges whether or not the communication key has been pressed (S225). In a case in which the communication key has been pressed (in a case of YES in S225), the main control unit 20 starts communication with the caller that corresponds to the incoming call (phone number other than the high-priority phone number) received in Step S201 (S227). In a case in which the communication key has not been pressed (in a case of NO in S225), the main control unit 20 judges whether or not any one of other keys has been pressed (S229). In a case in which any one of other keys has not been pressed (in a case of No in S229), the flow returns to Step S224 in which the main control unit 20 judges whether or not the incoming call has been disconnected.

In a case in which any one of other keys has been pressed (in a case of YES in S229), the main control unit 20 performs processing which is associated with the key thus pressed, and which differs from the communication processing (S231). The reason is that the caller does not match the high-priority phone number in this case, and accordingly, the user is permitted to perform other operations other than the incoming call response operation.

As described above, in a case in which the communication priority function is in the enabled state, and there is an incoming call from the caller that corresponds to the high-priority phone number, and in a case in which the user has not perform the incoming call response operation for a predetermined period or longer, or in a case in which the user gives an instruction to perform an operation other than the incoming call response operation, the mobile phone 1 transmits a position notice mail, which indicates the position of the mobile phone 1, to the mail address specified beforehand.

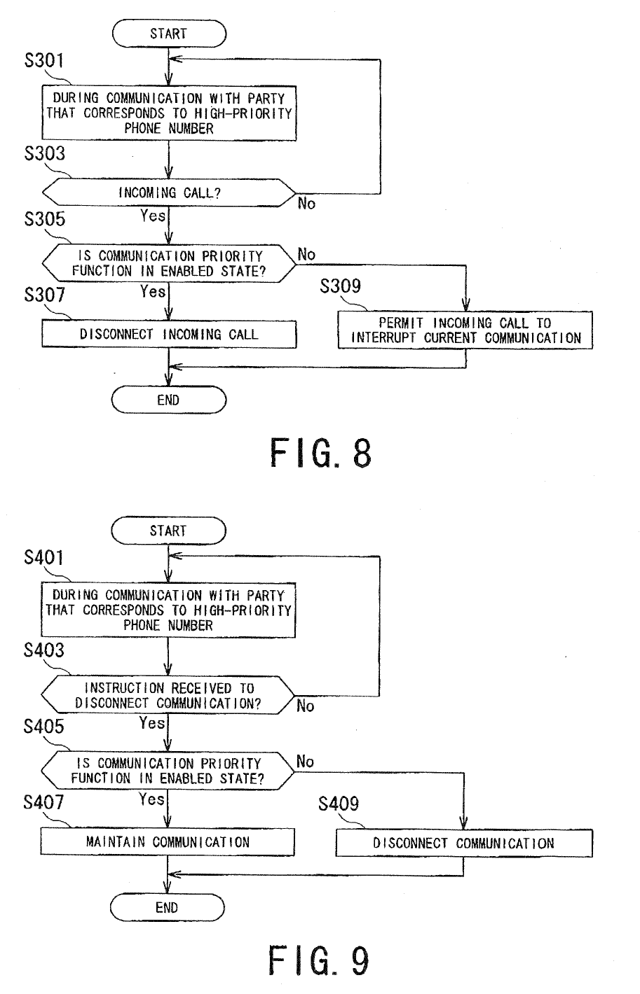

Next, description will be made with reference to the flowchart shown in FIG. 8 regarding the procedure of the communication priority processing in which, in a case in which there is a different incoming call from a different phone number during communication with a party that corresponds to the high-priority phone number (S301), the different incoming call is rejected based upon the setting information 30.

First, the main control unit 20 judges whether or not a different incoming call signal is received (S303). In a case in which no different incoming call signal is received (in a case of NO in S303), the flow returns to Step S301 in which the main control unit 20 maintains the communication.

In a case in which a different incoming call signal is received during communication with the party that corresponds to the high-priority phone number (in a case of YES in S303), the main control unit 20 judges whether or not the communication priority function is in the enabled state (S305). In this stage, the main control unit 20 acquires the communication priority function enable/disable setting information 32 from the storage unit 26, and judges whether or not this function is in the enabled state based upon this information. For example, referring to the setting information 30 shown in FIG. 4, the “always enabled” option is set for the communication priority function enable/disable setting information 32. Accordingly, determination is made that the communication priority function is in the enabled state.

In a case in which the communication priority function is in the enabled state (in a case of YES in S305), high priority is given to the communication with the party that corresponds to the high-priority phone number. Accordingly, the main control unit 20 disconnects the incoming call received in Step S303 (S307). In this stage, the mobile phone 1 preferably transmits a message which notify the different caller that the user is communicating with the party at a high priority level. On the other hand, in a case in which the communication priority function is not in the enabled state (in a case of NO in S305), the main control unit 20 permits the incoming call received in Step 3303 to interrupt the current communication (S309).

As described above, in a case in which the communication priority function is in the enabled state, and in a case in which there is an incoming call from a caller that does not match the high-priority phone number during communication with a party that corresponds to the high-priority phone number, the mobile phone 1 disconnects the incoming call from the caller that does not match the high-priority phone number.

Next, description will be made with reference to the flowchart shown in FIG. 9 regarding the procedure of the communication priority processing in which, during communication with a party that corresponds to the high-priority phone number (S401), in a case in which there is an instruction to disconnect this communication, the mobile phone 1 maintains this communication based upon the setting information 30.

First, the main control unit 20 judges whether or not there is an instruction to disconnect this communication (S403). In this stage, the main control unit 20 judges whether or not there is an instruction to disconnect the communication based upon whether or not the operation key 15 such as the on-hook key, the power off key, or the like has been pressed, for example. In a case in which there is no instruction to disconnect the communication (in a case of NO in S403), the flow returns to Step S401, and the main control unit 20 maintains the communication.

In a case in which there is an instruction to disconnect the communication (in a case of YES in S403), the main control unit 20 judges whether or not the communication priority function is in the enabled state (S405). In this stage, the main control unit 20 acquires the communication priority function enable/disable setting information 32 from the storage unit 26, and judges whether or not this function is in the enabled state based upon this information. For example, referring to the setting information 30 shown in FIG. 4, the “always enabled” option is set for the communication priority function enable/disable setting information 32. Accordingly, determination is made that the communication priority function is in the enabled state.

In a case in which the communication priority function is in the enabled state (in a case of YES in S405), high priority is given to the communication with the party that corresponds to the high-priority phone number. Accordingly, the main control unit 20 does not disconnect this communication, and maintains this communication (S407). On the other hand, in a case in which the communication priority function is not in the enabled state (in a case of NO in S405), the main control unit 20 disconnects the communication (S409).

As described above, in a case in which the communication priority function is in the enabled states and in a case in which, during communication with a party that corresponds to the high-priority phone number, there is an instruction to disconnect this communication, the mobile phone 1 does not permits the disconnection of the communication. It should be noted that this communication is disconnected according to the disconnecting operation by the party that corresponds to the high-priority phone number.

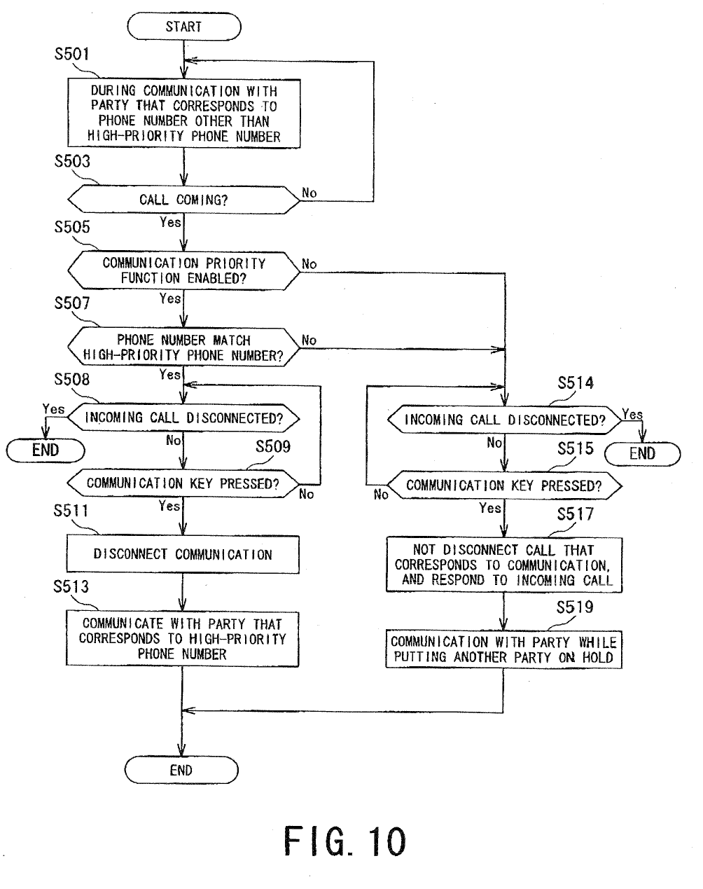

Next, description will be made with reference to the flowchart shown in FIG. 10 regarding the procedure of the communication priority processing in which, in a case in which, during communication with a party that does not match the high-priority phone number (S501), there is an incoming call from the caller that corresponds to the high-priority phone number, high priority is given to communication with the caller that corresponds to the high-priority phone number based upon the setting information 30.

First, the main control unit 20 judges whether or not a different incoming call signal is received (S503). In a case in which any different incoming call signal is not received (in a case of NO in S503), the flow returns to Step S501, and the main control unit 20 maintains the communication.

In a case in which a different incoming call signal is received (in a case of YES in S503), the main control unit 20 judges whether or not the communication priority function is in the enabled state (S505). In this stage, the main control unit 20 acquires the communication priority function enable/disable setting information 32 from the storage unit 26, and judges whether or not this function is in the enabled state based upon the information thus acquired. For example, referring to the setting information 30 shown in FIG. 4, the “always enabled” option is set for the communication priority function enable/disable setting information 32. Accordingly, determination is made that the communication priority function is in the enabled state.

In a case in which the communication priority function is in the enabled state (in a case of YES in S505), the control unit 20 judges whether or not the incoming call received in Step S503 matches the high-priority phone number (S507). In this stage, the main control unit 20 acquires the high-priority phone number information 31 from the storage unit 26, and judges whether or not the phone number of the incoming call matches the high-priority phone number based upon this information. For example, referring to the setting information 30 shown in FIG. 4, the phone number “090-1234-5677” is set for the high-priority phone number information 31. Accordingly, in a case in which there is an incoming call from this phone number in Step S503, determination is made that the phone number that corresponds to the incoming call matches the high-priority phone number.

In a case in which the phone number of the incoming call matches the high-priority phone number (in a case of YES in S507), the main control unit 20 outputs predetermined acoustic sound via the speaker 14 or the like, thereby notifying the user that a call is coming. The main control unit 20 judges whether or not the incoming call has been disconnected by the caller (S508). In a case in which the incoming call has been disconnected (in a case of YES in S509), the main control unit 20 ends the communication priority processing.

In a case in which the incoming call has not been disconnected (in a case of NO in S508), the main control unit 20 judges whether or not the communication key has been pressed (S509). In a case in which the communication key has not been pressed (in a case of NO in S509), the flow returns to Step S508 in which the main control unit 20 judges whether or not the incoming call has been disconnected.

In a case in which the communication key has been pressed (in a case of YES in S509), high priority is given to the communication with the party that corresponds to the high-priority phone number. Accordingly, the main control unit 20 disconnects the communication with the party that does not matches the high-priority phone number (S511). In this case, the mobile phone 1 preferably outputs a message so as to notify the party who communicated with the user and who does not match the high-priority phone number that the user has received an incoming call at high-priority level. Then, the main control unit 20 starts the communication with the party that corresponds to the high-priority phone number (S513).

In a case in which the communication priority function is not in the enabled state (in a case of NO in S505), or in a case in which the caller that corresponds to the incoming call received in Step S503 does not match the high-priority phone number (in a case of NO in S507), the main control unit 20 outputs a predetermined audio output via the speaker 14 or the like, thereby notifying the user that a call is coming. The main control unit 20 judges whether or not the incoming call has been disconnected by the caller (S514). In a case in which the incoming call has been disconnected (in a case of YES in S514), the main control unit 20 ends the communication priority processing.

In a case in which the incoming call has not been disconnected (in a case of NO in S514), the main control unit 20 judges whether or not the communication key has been pressed (S515). In a case in which the communication key has not been pressed (in a case of NO in S515), the flow returns to Step S514, and the main control unit 20 judges whether or not the incoming call has been disconnected.

In a case in which the communication key has been pressed (in a case of YES in S515), the main control unit 20 does not disconnect the communication with the party who is in communication in Step S501, and responds to the incoming call received in step S503 (S517). Then, the main control unit 20 puts the communication with the party who is in communication in Step S501 on hold, and starts the communication with the caller that corresponds to the incoming call received in Step S503 (S519).

As described above, in a case in which the communication priority function is in the enabled state, and in a case in which, during communication with a party that does not match the high-priority phone number, there is an incoming call from the caller that corresponds to the high-priority phone number, the mobile phone 1 disconnects the communication with the party that does not match the high-priority phone number, and responds to the incoming call from the high-priority phone number.

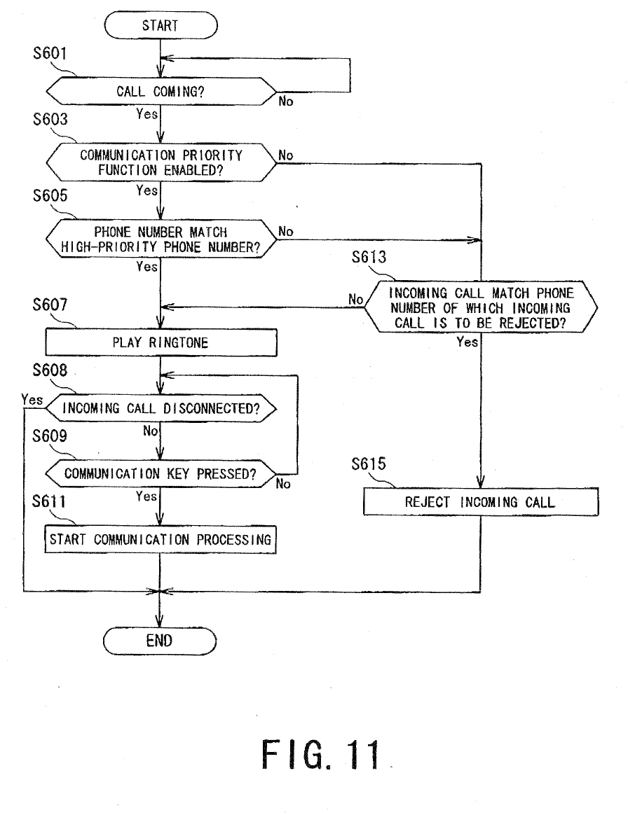

Next, description will be made with reference to the flowchart shown in FIG. 11 regarding the procedure of the communication priority processing in which, in a case in which there is an incoming call from the caller that matches the phone number of which an incoming call is to be rejected, the mobile phone 1 rejects the incoming call based upon the setting information 30.

First, the main control unit 20 judges whether or not an incoming call signal is received (S601). In a case in which no incoming call signal is received (in a case of NO in S601), the main control unit 20 maintains the standby state. In a case in which an incoming call signal is received (in a case of YES in S601), the main control unit 20 judges whether or not the communication priority function is in the enabled state (S603). In this stage, the main control unit 20 acquires the communication priority function enable/disable setting information 32 from the storage unit 26, and judges whether or not the function is in the enabled state based upon this information. For example, referring to the setting information 30 shown in FIG. 4, the “always enabled” option is set for the communication priority function enable/disable setting information 32. Accordingly, determination is made that the communication priority function is in the enabled state.

In a case in which the communication priority function is in the enabled state (in a case of YES in S603), the main control unit 20 judges whether or not the phone number that corresponds to the incoming call received in Step S601 matches the high-priority phone number (S605). In this stage, the main control unit 20 acquires the high-priority phone number information 31 from the storage unit 26, and judges whether or not the phone number that corresponds to the incoming call matches the high-priority phone number based upon this information. For example, referring to the setting information 30 shown in FIG. 4, the phone number “090-1234-5678” is set for the high-priority phone number information 31. Accordingly, in a case in which there is an incoming call from this phone number in Step S601, determination is made that the phone number that corresponds to the incoming call matches the high-priority phone number.

In a case in which the phone number that corresponds to the incoming call matches the high-priority phone number (in a case of YES in S605), the main control unit 20 plays the ringtone, thereby notifying the user that a call is coming (S607). The main control unit 20 judges whether or not the incoming call has been disconnected by the caller (S608). In a case in which the incoming call has been disconnected (in a case of YES in S608), the main control unit 20 ends the communication priority processing.

In a case in which the incoming call has not been disconnected (in a case of No in S608), the main control unit 20 judges whether or not the communication key has been pressed (S609). In a case in which the communication key has not been pressed (in a case of NO in S609), the flow returns to Step S608, and the main control unit 20 judges whether or not the incoming call has been disconnected.

In a case in which the communication key has been pressed (in a case of YES in S609), the main control unit 20 starts the communication with the caller that corresponds to the incoming call received in Step S601, i.e., the caller that corresponds to the high-priority phone number (S611).

In a case in which the communication priority function is not in the enabled state (in a case of NO in S603), or in a case in which the caller that corresponds to the incoming call received in Step S601 does not match the high-priority phone number (in a case of NO in S605), the main control unit 20 judges whether or not the phone number that corresponds to the incoming call received in Step S601 matches the phone number of which the incoming call is to be rejected (S613). In this stage, the main control unit 20 acquires the incoming call rejection information 39 from the storage unit 26, and determines based upon this information whether or not the phone number that corresponds to the incoming call matches the phone number of which the incoming call is to be rejected. For example, referring to the setting information 30 shown in FIG. 4, the phone number “090-4321-8765” is set for the incoming call rejection information 39. Accordingly, in a case in which there is an incoming call from this phone number in Step S601, determination is made that the phone number that corresponds to the incoming call matches the phone number of which the incoming call is to be rejected.

In a case in which the phone number that corresponds to the incoming call received in Step S601 does not match the phone number of which the incoming call is to be rejected (in a case of NO in S613), the caller that corresponds to the incoming call received in Step S601 does not match the caller of which the incoming call is to be rejected. Accordingly, the flow returns to Step S607, and the main control unit 20 plays the ringtone, thereby notifying the user that a call is coming.

In a case in which the phone number that corresponds to the incoming call received in Step S601 matches the phone number of which the incoming call is to be rejected (in a case of YES in S613), the caller that corresponds to the incoming call received in Step S601 matches the caller of which the incoming call is to be rejected. Accordingly, the main control unit 20 rejects this incoming call (S615).

As described above, in a case in which the communication priority function is in the enabled state, and in a case in which there is an incoming call from a caller that corresponds to the high-priority phone number, the mobile phone 1 allows the user to respond to the incoming call. On the other hand, in a case in which there is an incoming call from a caller that does not match the high-priority phone number, the mobile phone 1 judges whether or not the incoming call matches the caller of the phone number of which the incoming call is to be rejected. Only in a case in which the incoming call does not match the caller of the phone number of which the incoming call is to be rejected, the mobile phone 1 permits the user to respond to this incoming call.

Description has been made in the embodiment of the mobile phone 1 regarding an arrangement in which a single phone number is registered as the high-priority phone number. The present invention is not restricted to such an arrangement. Also, multiple phone numbers may be registered as a high-priority phone number group.

Also, the mobile phone 1 preferably has a function whereby, in a case in which the user operation password information 30 has been set, and in a case in which the user has given an instruction to perform an operation other than the incoming call response operation (forwarding operation, incoming call rejection, incoming call response holding operation, operation for responding with an answering service, etc.) via the operation keys 15 when the incoming call has been received, a password input request screen is displayed on the display 13 which allows the user to input a password, and only in a case in which the user has input the correct user operation password, the mobile phone 1 permits the user to perform the operation other than the incoming call response operation.

Description has been made in the embodiment of the mobile phone 1 regarding an arrangement in which the setting information 30 is stored in only the storage unit 26. However, the present invention is not restricted to such an arrangement. For example, an arrangement may be made in which the setting information 30 is stored in a USIM card, in addition to the storage unit 26. With such an arrangement, the setting information 30 is effectively used, even if the USIM card is inserted into a different mobile phone.

With such an arrangement, the mobile phone 1 preferably does not permit the user to reject the high-priority phone number, even if the high-priority phone number is set for the incoming call rejection information 39.

With the mobile phone 1 according to the present invention, based upon the settings of the communication priority function, high priority is given to the caller that corresponds to the high-priority phone number even when the user is in communication with a party that does not match the high-priority phone number. Also, when the user is in communication with the party that corresponds to the high-priority phone number, an incoming call from a different party that does not match the high-priority phone number is disconnected. Also, the mobile phone 1 limits the operations that differ from the response operation for the incoming call from the caller that corresponds to the high-priority phone number, and so forth. Thus, such an arrangement gives high priority to the communication with a party that corresponds to a particular phone number (high-priority phone number), and allows the setting of whether or not the priority function is enabled to be easily made.

Description has been made regarding the mobile phone 1 according to the present invention. However, the present invention is not restricted to such an arrangement. Also, the present invention can be applied to desired communication terminals such as a PHS (Personal Handyphone System), PDA (Personal Digital Assistants), etc.

What is claimed is:

1. A mobile phone comprising:
a first judging unit which judges whether or not the caller of an incoming call matches a predetermined phone number if the incoming call signal is received; and
a limiting unit configured such that, in a case in which the first judging unit judges that the caller of the incoming call matches the predetermined phone number, the limiting unit limits operations other than an incoming call response operation.

2. A mobile phone according to claim 1, further including a receiving unit which receives an input which is an instruction to enable or disable a communication priority function,
wherein, in a case in which the receiving unit receives an input so as to enable the communication priority function, the limiting unit limits operations other than the incoming call response operation.

3. A mobile phone according to claim 2, further including a second judging unit which judges whether the communication priority function is in the enabled state or the disabled state,
wherein, in a case in which the second judging unit judges that the communication priority function is in the disabled state, the limiting unit permits the operations other than the incoming call response operation.

4. A mobile phone according to claim 1, wherein the first judging unit judges whether each of the operations other than the incoming call response operation is permitted or unpermitted,
and wherein, in a case in which the first judging unit judges that an operation is unpermitted, the limiting unit forbids this operation.

5. A mobile phone according to claim 1, wherein the operation other than the incoming call response operation is any one of a response rejection operation, a forwarding operation, and a response holding operation.

6. A mobile phone according to claim 1, wherein, in a case in which the first judging unit judges that the caller of an incoming call matches the predetermined phone number, and in a case in which an operation other than the incoming call response operation is performed, a position notice mail including the position information of the mobile phone is transmitted to a predetermined destination.

7. A mobile phone according to claim 1, wherein, in a case in which the first judging unit judges that the caller of an incoming call matches the predetermined phone number, and in a case in which the incoming call response operation is not performed for a predetermined period of time or longer, a position notice mail including the position information of the mobile phone is transmitted to a predetermined destination.

8. A mobile phone according to claim 1, further including a communication control unit configured such that, in a case in which a call that does not match the predetermined phone number comes during communication with a party that corresponds to the predetermined phone number, the incoming call from a phone number other than the predetermined phone number is rejected.

9. A mobile phone according to claim 8, wherein, when the communication control unit rejects an incoming call from a phone number other than the predetermined phone number, a message is transmitted to the phone number other than the predetermined phone number to the effect that the incoming call is rejected.

10. A mobile phone according to claim 1, further including:
a receiving unit which receives an input which is an instruction to disconnect a communication; and
a communication control unit configured such that, in a case in which the receiving unit receives an input during communication with a party that corresponds to the predetermined phone number, the communication control unit maintains this communication operation.

11. A mobile phone according to claim 1, further including a communication control unit configured such that, in a case in which a call comes during the communication with a party that corresponds to a phone number other than the predetermined phone number, and in a case in which the first judging unit judges that the caller of the incoming call matches the predetermined phone number, the communication control unit disconnects the communication with the party that corresponds to the phone number other than the predetermined phone number, and responds to the incoming call from the predetermined phone number.

12. A mobile phone according to claim 11, wherein, when the communication control unit disconnects the communication with a party that corresponds to a phone number other than the predetermined phone number, the communication control unit transmits a message to the phone number other than the predetermined phone number to the effect that the communication is disconnected.

13. A mobile phone according to claim 1, further including:
a setting unit which allows a phone number of which the incoming call is to be rejected to be set; and
a communication control unit configured such that, after the setting unit sets the predetermined phone number to the phone number of which the incoming call is to be rejected, in a case in which the first judging unit judges the caller of the incoming call matches the predetermined phone number when a call comes, the communication control unit permits the communication with the caller that corresponds to the predetermined phone number.

14. A mobile phone according to claim 13, wherein, in a case in which the first judging unit judges the caller of the incoming call does not match the predetermined phone number when a call comes, and in a case in which the incoming call matches a phone number set by the setting unit to the phone number of which the incoming call is to be rejected, the communication control unit rejects the incoming call.

15. A method for limiting operations of a mobile phone comprising:
a first judging step of judging whether or not the caller of an incoming call matches a predetermined phone number if the incoming call signal is received; and
a limiting step of limiting operations other than an incoming call response operation in a case in which it is judged that the caller of the incoming call matches the predetermined phone number in the first judging step.

16. A method for limiting operations of a mobile phone according to claim 15, further comprising:
a communication control step of, in a case in which a call that does not match the predetermined phone number comes during communication with a party that corresponds to the predetermined phone number, rejecting the incoming call from a phone number other than the predetermined phone number.

17. A method for limiting operations of a mobile phone according to claim 16, wherein, in the communication control step, when an incoming call from a phone number other than the predetermined phone number is rejected, a message is transmitted to the phone number other than the predetermined phone number to the effect that the incoming call is rejected.

18. A method for limiting operations of a mobile phone according to claim 15, further comprising:
a receiving step of receiving an input which is an instruction to disconnect a communication; and
a communication control step of, in a case in which an input is received during communication with a party that corresponds to the predetermined phone number in the receiving step, maintaining this communication operation.

19. A method for limiting operations of a mobile phone according to claim 15, further comprising:
a communication control step of, in a case in which a call comes during the communication with a party that corresponds to a phone number other than the predetermined phone number, and in a case in which the first judging unit judges that the caller of the incoming call matches the predetermined phone number, disconnecting the communication with the party that corresponds to the phone number other than the predetermined phone number, and responding to the incoming call from the predetermined phone number.

20. A method for limiting operations of a mobile phone according to claim 19, wherein, in the communication control step, when the communication with a party that corresponds to a phone number other than the predetermined phone number is disconnected, a message to the phone number other than the predetermined phone number to the effect that the communication is disconnected is transmitted.
